(19) United States
(12) Patent Application Publication
(10) Pub. No.: US 2008/0095893 A1
(43) Pub. Date: Apr. 24, 2008

(54) Colouring and Flavouring Capsules Provided in a Gel Medium, and Method and Apparatus for Making Same

(75) Inventors: Alvaro Otalora, Chia (CO); Orlando Camacho, Bogota (CO); Oscar Guzman, Bogota (CO); Miguel Angel Herrera, Chia (CO); Jorge Humberto Orjuela, Bogata (CO); Orlando Gomez, Sopo (CO)

Correspondence Address: OBLON, SPIVAK, MCCLELLAND MAIER & NEUSTADT, P.C., 1940 DUKE STREET, ALEXANDRIA, VA, 22314, US

(73) Assignee: ALPINA PRODUCTOS ALIMENTICIOS S.A., Sopo (CO)

(21) Appl. No.: 10/560,364

(22) PCT Filed: Jun. 12, 2003
(86) PCT No.: PCT/IB03/02255

§ 371 Date: Nov. 30, 2007

(51) Int. Cl. A23L 1/0532; A23L 1/054; A23L 1/0562; A23L 1/275

(52) U.S. Cl. 426/92; 426/102; 426/103; 426/232; 426/233; 426/250; 426/276; 426/307; 426/89; 99/450.6

(57) ABSTRACT

Capsules made of gellan gum and a polyvalent salt and having various flavors and colors are provided in a flexible gelatin and carragheenan gel, of which the appearance differs from that of ordinary gelatin, by suspending the capsules having various flavors and colors in a gel medium by adjusting the process variables and formulation to prevent color and flavor migration into the gel medium.

### FIELD OF THE INVENTION

The invention describes the industrial obtaining of edible capsules, of different flavor and color, within a gel, which alters the esthetic appearance of ordinary gelatin, when the capsules of different colors are suspended in a gelled medium, through manipulation of process and formulation variables.

It likewise describes the design of a unit for the industrial, assembly-line production of the mentioned capsules and the technological adaptation of the mixing and packing process for obtaining of the finished product. (See FIG. 1 attached).

### BACKGROUND OF THE INVENTION

Products in the form of gel, known as gelatin, the presentations of which vary in form, color, flavor and other characteristics, are known in the art. The most common ingredient used for these edible products is the so-called gellan gum, which is a heteropolysaccharide prepared by the fermentation of Pseudomonas Elodea ATCC31461. Gellan gum is an ingredient that is obtained commercially, marketed by the Kelco Division of Monsanto Co., San Diego, Calif., under various names including Kelco Gel, Kelco Gel P. C. and Kelco F., processed for the preparation of gellan gum, also described under U.S. Pat. Nos. 4,326,052 and 4,326,053.

U.S. Pat. No. 5,654,027 describes a gellan-gum concentrate and a dispersion for use in fluid gels. This invention comprises a dual function of suspension agent and texture modifier for use in beverages and other consumable fluids. The concentrated gum consists of a mixture of gellan gum, a sequestering agent and a calcium salt. The mixture preferably is used to prepare a unique gelatinous beverage in which the flavors and other ingredients are uniformly distributed for a taste and texture highly pleasing to the palate.

U.S. Pat. No. 5,576,039 describes a colored substance of gelatinous type, the method of preparation and the composition. There is provided a substance of gelatinous type that incorporates a color insoluble in water. This substance can be incorporated into a liquid composition that has a pH acidity between approximately 2.5 and 6.0 and the color remains incorporated into the gelatinous substance. There is also provided a liquid composition that includes substances of the gelatinous type and a method for incorporating water-soluble substances into said gelatinous substance. U.S. Pat. No. 6,183,801 B1 discloses a gelatinous composition for foods that includes bits of fruit and preparation thereof. A gelatinous composition that contains bits of fruit distributed therein is obtained by preparing, separately, a gelatinous base and a fruit composition that contains bits of fruit. Then the two compositions are combined and cooled in order to obtain the final composition.

The gelatin-based products known in the art present problems insofar as the components other than gelatin contained within the gel medium allow flavors, colors and other characteristics to migrate, directly affecting the appearance, texture, color and even flavor of gel used.

### SUMMARY OF THE INVENTION

In order to resolve the disadvantages presented by the state-of-the-art gelatin products, this invention provides a novel product consisting in general of some capsules of different colors and flavors that are suspended in an edible gelatinous medium in such a way that there is no migration of the characteristics of the capsules, as for example color, flavor, texture, toward the gel medium or gelatin, thus preserving the original presentation thereof.

The invention centers on the stabilization of the oil-soluble color and flavor in the encapsulation, so that they do not migrate toward the completely transparent gel medium during the gelling process.

In order to achieve the proposed result, this invention also involves the process for the manufacture of the capsules in the gelled medium and the apparatus or machine for accomplishing it.

### BRIEF DESCRIPTION OF THE DRAWINGS

FIG. 1 shows a schematic container illustrative of the commercial presentation of the product that makes it possible to see in the interior thereof the product that is the subject of this invention.

FIG. 2 is a schematic diagram of a machine illustrative of the invention for forming the product of FIG. 1 using the process of the invention.

### DETAILED DESCRIPTION OF THE INVENTION

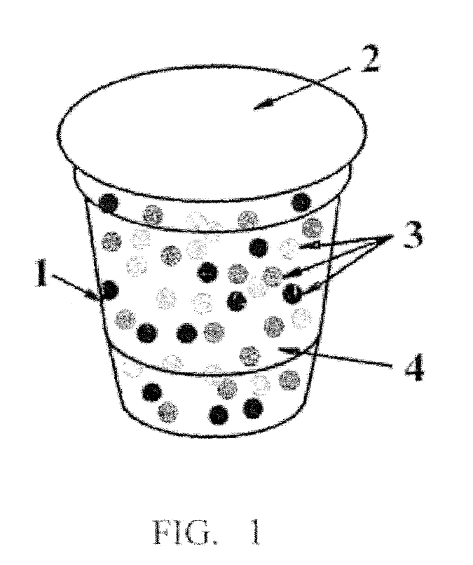

Referring to FIG. 1, there can be seen a jar-type container 1, that has over its upper opening a cover made of aluminum foil to close the container. Inside said container is the product consisting of a gel medium 4 and one or more capsules 3 of assorted colors and flavors. Said capsules 3 are manufactured so that migration of the color or the flavor toward the gel medium 4 is prevented and therefore the original characteristics of said gel medium 4 likewise are prevented from changing. This corresponds to a preferred embodiment of the invention.

The product of the invention can be packaged in suitable containers for direct consumption by the user, as for example jar-type containers, or any other type of appropriate receptacle.

The capsules 3 of the invention are obtained by preparing a base mixture, a monovalent/divalent saline solution and a syrup, which are used later on in a special machine for the manufacture of the capsules 3.

The base mixture generally consists of the following components: an aqueous medium, one or more polysaccharides, gelling agents, salts, flavors, colors and emulsifiers.

The aqueous medium preferably can be water or any other medium suitable for this purpose. The polysaccharides preferably are chosen from among saccharose, gellan gum, xanthan or any other polysaccharide suitable for this type of product. Among the salts there preferably are used alginate, sodium citrate, sodium chloride or any other salt suitable for this purpose. Various flavors chosen from among those of the oil-soluble type are used. There also are used various colors of the oil-soluble type, preferably natural, suitable for use in foods, for example Annatto, Chlorophyll or Carmine. Finally, emulsifiers with an HLB value between 14-16, suitable for this purpose, are used.

The manufacture of the base mixture is carried out in a vessel that has temperature control and stirring means with a heating and/or cooling system. There is added into the vessel between 0.5 and 0.7% of emulsifier by weight of the mixture and it is melted by heating to a minimum temperature of 70° C., wherein there is to be taken into account the hydro-liposoluble ratio with an HLB value between 14 and 16, which minimizes the diffusion of color between the capsules and the gel medium in the final product. Once the emulsifier is melted, between 2.5 and 3.0% of oil-soluble flavor and between 0.65 and 0.75% of oil-soluble natural color defined as desired are added. The mixture is kept under constant stirring until the ingredients are mixed in a completely homogeneous manner at a minimum temperature of 70° C. The preparation of the color and flavor mixture is carried out independently for each one of the defined colors and flavors. In a parallel manner, between 79 and 82 of the aqueous mixture is heated to a maximum temperature of 80° C. without allowing boiling to occur in order to prevent evaporation in the mixture. Introduce into the whole of a polysaccharide that is between 13.5 and 14.5% by total weight of the base mixture, a first and a second and a third gelling agent that are between 0.8 and 1.0% by total weight of the base mixture and a first salt between 0.25 and 0.35% and a second salt between 0.1 and 0.2% in order to allow better incorporation and dissolution thereof in the final mixture. Once all the preceding ingredients are mixed, they are to be added to the hot aqueous medium, with constant stirring until completely diluting all the mentioned ingredients and obtaining a base with mean viscosity of 500 mPa·s and a mean density of 1.0523 g/cm³ Now the emulsion of integrated color and flavor is added to the preceding mixture, with constant stirring and at a maximum temperature of 80° C. until total dispersion thereof. Once the dispersion is obtained, it is to be cooled rapidly to 25° C., with constant stirring to prevent the formation of lumps and the inclusion of air. This final base mixture is kept under stirring at 25° C.; evaporation within the final mixture is to be avoided since with a lesser activity of water a_{w}, the rheological characteristics within the base change, less fluidity occurring and preventing formation of the capsule.

There is given below an illustrative example of a formulation of base mixture that can be used to obtain the product of the invention:

| INGREDIENTS | % |
|---|---|
| Water | 79%-82% |
| Saccharose | 13.5%-14.5% |
| Gellan Gum/Alginate/Xanthan | 0.8%-1.0% |
| Sodium Citrate | 0.25%-0.35% |
| Natural Oil-soluble Color | 0.65%-0.75% |
| Oil-soluble flavor | 2.5%-3.0% |
| Sodium Chloride | 0.1%-0.2% |
| Emulsifier | 0.5%-0.70% |

There now is described the method for preparing the monovalent/divalent saline solution that consists of: an aqueous medium, an acid and a monovalent/divalent first salt and second salt.

The aqueous medium can be water or another medium suitable for this purpose. The acid preferably is citric acid or another acid suitable for use in foods and for the purpose of this invention. The first divalent preferably is of an alkaline-earth metal (Magnesium and/or Calcium), as for example calcium chloride salt, although it is not to be limited to this salt alone, and the second monovalent salt preferably is a sodium chloride salt, although it is not to be limited to this salt alone. Other salts suitable for foods and for the purpose of this invention also can be used.

The process for preparation of the saline solution consists in pasteurizing between 88 and 90% of aqueous medium at a temperature of 90° C. for 15 s. Then it is cooled to an ambient temperature of minimum 20° C. and a first divalent salt and the acid are added very slowly. There now is added a second monovalent salt which aids, with the first, in increasing the elasticity and consistency of the capsules at the time of formation of same. Said acid is between 3.0 and 3.5% by weight of said saline solution and said first and second salts are between 7.0 and 8.0% by weight of the saline solution. It is kept under constant, slow stirring, taking into account that an exothermic reaction is involved, it is kept at an approximate temperature of 80° C. until total dissolution of the ingredients. The physico-chemical variables, minimum pH of 1.4 and a minimum concentration of 8.5 degrees Baumé are checked. Now it is stored in the tank of the capsule-forming machine.

There is given below an illustrative example of a formulation of the monovalent/divalent saline solution that can be used to obtain the product of the invention:

| INGREDIENTS | % |
|---|---|
| Water | 88%-90% |
| Citric Acid | 3.0%-3.5% |
| Calcium chloride/Sodium | 7.0%-8.0% |
| chloride | |

There now is described the preparation of the third component of the capsules, which is a syrup that consists of an aqueous medium, a polysaccharide and salts.

The aqueous medium preferably can be water or another medium suitable for this purpose. The polysaccharide preferably is saccharose or another polysaccharide suitable for use in foods and for the purpose of this invention. The salts preferably are salts of potassium sorbate and sodium benzoate, although they are not to be limited to these salts alone. These salts are preservatives. Other salts suitable for foods and for the purpose of this invention also can be used.

The preparation of said syrup comprises pasteurizing in the boiler between 86 to 88% by weight of the syrup, the aqueous medium, at a temperature of 90° C. for 15 s. Introduce into the total polysaccharide, which is between 12 and 14% by weight of the syrup, the preservative salts in a quantity between 0.08 and 0.1% by weight of the syrup, to be added to the aqueous medium later on. Cool to a temperature of approximately 20° C. and store the syrup in vessels disinfected beforehand, since this solution will be the conveying medium for the storage, preservation and subsequent dispersion of the capsules in the gelling medium. Now the physico-chemical variables of the syrup, minimum concentration of 11.0 degrees Brix, are checked. The syrup is to be kept refrigerated until its use, for storage of the capsules formed in the machine.

There is given below an illustrative example of a formulation of the syrup that can be used to obtain the product of the invention:

| SYRUP INGREDIENTS | % |
|---|---|
| Water | 86%-88% |
| Saccharose | 12%-14% |
| Potassium | 0.08%-0.1% |
| Sorbate/Sodium Benzoate | |

Once the three preceding elements, the base mixture, the monovalent/divalent saline solution and the syrup are present, formation of the capsules is undertaken in accordance with the following process.

First of all the monovalent/divalent saline solution is placed in a storage tank that has a viscous flow recirculation system for said solution. Secondly, the base mixture goes on to a dispensing hopper by pumping said mixture from the boiler to the dispensing hopper up to a defined level, generating a column of fluid that ensures the pressure and speed of the flow. The base mixture flows from the base hopper through dispensing needles, forming a constant and homogenous dripping that is to be checked visually for the purpose of ensuring the size and uniformity of same. Said drops are received in the monovalent/divalent saline solution that is in said storage tank, which is a hardening medium for the capsules. As soon as contact of the drops of base mixture with said hardening medium occurs, the flavor and color capsule is formed, through contact with the calcium ion that adheres to the first and second gelling agents, immediately hardening through changes in the chemical characteristics that are perceived rheologically. The capsules are left submerged in said monovalent/divalent saline solution for an approximate time of 4 minutes manifested by the travel of a conveyor belt that is used for the evacuation of the capsules from the recirculation tank for the monovalent/divalent saline solution in the following stage of rinsing of the capsules. Afterwards the size and weight of the capsules obtained, which should have an average diameter of 3.5 to 4.0 mm, an approximate weight of 0.045 g and a density of 0.865 g/cm³, are checked. After the capsules emerge from the monovalent/divalent saline solution, they go on to a second stage of spray washing with cold water, for the purpose of eliminating the residual salty taste and aiding in the hardening of the walls. The washing time is approximately 5 minutes. Then the washed flavor capsules are collected in the syrup mentioned above and are stored in a capsule:syrup ratio of 60:40, said syrup is used as a conveying medium during mixing with the gel base in order to ensure dispersibility in the final product. The capsules stored as intermediate product are stored in said syrup. Storage is to be carried out at a temperature between 4 and 6° C.

Next, finishing of the final product is undertaken by producing the edible capsules within a gel. First the procedure for obtaining the gelling medium will be described.

The gelling medium generally consists of the following components: an aqueous medium, one or more polysaccharides, a gel-forming agent, a gelatinous protein, a salt, a first acid and a second acid and a flavoring agent.

The aqueous medium preferably is drinking water or any other aqueous medium suitable for this purpose. The polysaccharides preferably can be saccharose, or any other polysaccharide suitable for this type of product. The gel-forming agent preferably is carrageenan or another one suitable for this purpose. The gelatinous protein preferably is collagen or another one suitable for the purpose of this invention. The salt preferably is chosen from sodium citrate or another appropriate one. The first acid preferably is citric acid, although another appropriate one can be used, and the second acid preferably is ascorbic acid or another one appropriate for this purpose, lastly the flavoring agent.

The manufacture of the gelling medium is carried out by means of the following process. At first the polysaccharide, between 14.0 and 16.0% by weight of the gelling medium, is placed in a mixer; the dry elements are added thereto, that is, the gel-forming agent and the gelatinous protein, in a quantity between 4.0 and 4.5% by weight of the gelling medium, the salt and the first acid in a quantity between 0.9 and 1.2% by weight of the gelling medium, the second acid in a quantity between 0.03% and 0.05% by weight of the gelling medium and the flavoring agent in a quantity between 0.5 and 0.7% by weight of the gelling medium.

Now the aqueous medium of the formulation is heated to a minimum of 40° C. in order to ensure the dissolution of the mixture of dry products. The dry ingredients are added conveyed in a mixing cone in order to incorporate them into the aqueous medium of the formulation, with constant recirculation. Once all the ingredients are mixed and homogenized, the process of pasteurization is initiated at a minimum temperature of 75° C. for 15 s and afterwards it is cooled to 30° C. Then cooling to a temperature of maximum point 19° C. is undertaken prior to the start of gelling of the gelling medium.

There is given below an illustrative formulation of the gelling medium that can be used in this invention:

| INGREDIENTS | % |
|---|---|
| DRINKING WATER | 77.5%-80% |
| SACCHAROSE | 14.0%-16.0% |
| COLLAGEN/CARRAGEENAN | 4.0%-4.5% |
| SODIUM CITRATE/CITRIC | 0.9%-1.2% |
| ACID | |
| ASCORBIC ACID | 0.03%-0.05% |
| FLAVOR | 0.5%-0.7% |

Now storage of the final product of the invention is undertaken under the already defined temperature conditions in a finished-product tank under constant stirring in order to keep the obtained mixture fluid. The difference in densities between the gelling medium (1.06 to 1.07 g/cm³) and the rigid capsule (0.860 to 0.870 g/cm³) and the viscosity of the gelling medium ensures suspension in the fluid gelling medium at the defined temperatures. The product behaves as a Newtonian fluid with constant viscosity at a temperature of 19° C. When entry of the gelling medium into the finished-product tank begins, the preserved rigid capsules are added through the upper portion of the tank. This final mixture is kept under stirring for 10 minutes, during which time reduction of the temperature and consequently the gelling of the gelatinous protein is started. Adjustment of the process in terms of temperature and speed of stirring makes it possible to ensure distribution of the capsules in the gelling medium and suspension thereof in the liquid, viscous gelling medium in the gelling phase; at this point the gelling medium behaves as a non-Newtonian fluid, that is, with variable viscosity at the same temperature.

Once the product is in this state with the capsules suspended, it then is routed by means of a pumping system to the packing stage, ensuring the integrity of the capsules on the way to a packing machine. Once the product reaches a packing-machine hopper, the process of packing of the final product is initiated, wherein there is a temperature control system in order to maintain the temperature within a tolerance of +/−1° C. The product then is packaged in receptacles that have a capacity of approximately 120 g, although this type of container does not limit the invention since adjustments easily can be made in the process so as to package the final product in containers of various forms and capacities.

Then, once the container has been filled with the edible capsules within gel, it is sealed with an aluminum foil strip. The materials that are used for packing of the product of this invention are subjected to a cleaning process in a hydrogen peroxide bath with a minimum concentration of 10% p/p by spraying, for the purpose of ensuring asepsis. Afterwards the hydrogen peroxide is eliminated through evaporation and decomposition in water and O₂ in a drying chamber at a temperature between 130 and 135° C.

Once the product has been packed, the presentation thereof as to suspension of the capsules and concentration of same is checked, and then it goes on to a refrigeration tunnel for the purpose of allowing finalization of the gelling process that had started in the mixing tank and ensuring the characteristics of this invention.

For the purpose of being able to achieve the product of this invention, there is required a novel machine that not only makes it possible to control the physico-chemical characteristics of the components and mixtures but also for a uniform and dependable industrial product to be achieved. For this reason there is considered as an integral part of this invention a suitable and novel machine or unit for the production of the edible capsules within a gel medium in accordance with the teachings of this invention.

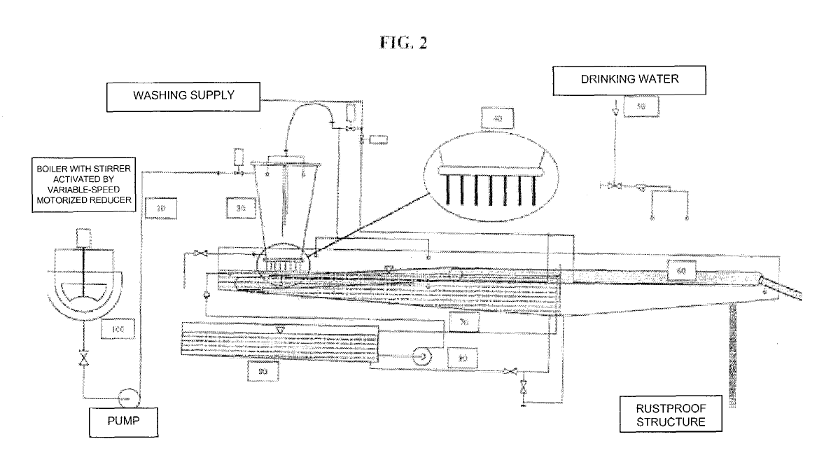

Referring to FIG. 2, there is shown a schematic diagram of the machine or unit required in order to produce the edible capsules within gel of this invention. In item 10 there is shown the piping that carries the base mixture that is being pumped from the manufacturing vessel 100. The mixture is discharged into a capsule dispensing means. Said dispenser consists essentially of a hopper that has a jacket for heating and/or cooling, with an inlet for the product, a level control and a connection for washing. In the lower portion there is a plate that has one or more needles 40 with a diameter of 2.5 mm which generate capsule-forming drops. Preferably 200 needles 40 are provided. As already mentioned previously, through the needles 40 fall drops of the base mixture which harden upon falling into a tank 70 filled with the monovalent/divalent saline solution, forming the capsules. There is a second tank 90 that contains the same monovalent/divalent saline solution and a fluid conveyance system 80 to recirculate said solution. Inside the tank 70 there is a conveyor belt 60 serving to move the capsules out and route them to two water-shower and spray-washing stations 50 to rinse and wash the capsules. Now the capsules are stored mixed with the syrup and refrigerated. In a parallel manner, a mixing tank in which the gel medium is prepared is used. Once it is prepared, it goes on to a final-product tank in which it is mixed with the mixture of capsules and syrup. Said tank has means for stirring and temperature control. Lastly, the final but not completely gelled product goes on to the packing machine in which the product is packed in suitable containers for its subsequent sale to the user. Once the containers are filled and closed, finalization of the gelling by means of refrigerating is undertaken.

Although the preceding description sets forth embodiments of the invention by way of illustration, those skilled in the art can see that changes and variations can be made in the procedures and the machines without departing from the spirit and scope of the invention, which is defined in its scope by the attached claims.

1. An edible product of capsules within a gel medium that comprises
One or more capsules of different colors and flavors
A gel medium
The mixture of both components is packed in a transparent plastic receptacle.

2. The product of claim 1, in which said one or more capsules are manufactured by preparing a base mixture, a capsule-forming solution and a syrup.

3. The product in accordance with any one of the preceding claims, in which said base mixture consists generally of the following components: an aqueous medium, one or more polysaccharides, gelling agents, salts, flavors, colors and emulsifiers.

4. The product in accordance with any one of the preceding claims, in which the aqueous medium is water.

5. The product in accordance with any one of the preceding claims, in which the polysaccharides preferably are chosen from saccharose or any other suitable polysaccharide.

6. The product in accordance with any one of the preceding claims, in which the gelling agents are gellan gum, alginate and xanthan, or any other agent suitable for this type of product.

7. The product in accordance with any one of the preceding claims, in which the salts preferably used are sodium citrate, sodium chloride or any other salt suitable for this purpose.

8. The product in accordance with any one of the preceding claims, in which the various flavors are chosen from among those of the oil-soluble type.

9. The product in accordance with any one of the preceding claims, in which the various colors are suitable for use in foods and are of the oil-soluble, preferably natural, type.

10. The product in accordance with any one of the preceding claims, in which the colors are chosen from among Annatto, Chlorophyll or Carmine or a mixture thereof, or any other suitable one.

11. The product in accordance with any one of the preceding claims, in which emulsifiers suitable for this purpose are used.

12. The product in accordance with any one of the preceding claims, in which said emulsifier is between 0.5 and 0.7% by weight of the mixture, the oil-soluble flavor is between 2.5 and 3.0%, the oil-soluble natural color is between 0.65 and 0.75%, a polysaccharide is between a 13.5 and a 14.5% by total weight of the base mixture, first, second and third gelling agents that are between 0.8 and 1.0% by total weight of the base mixture and a first salt between 0.25 and 0.35% and a second salt between 0.1 and 0.2% by weight of the base mixture.

13. The product in accordance with claim 12, in which the polysaccharide is saccharose.

14. The product in accordance with claim 12, in which the first gelling agent is Gellan Gum.

15. The product in accordance with claim 12, in which the second gelling agent is alginate.

16. The product in accordance with claim 12, in which said third gelling agent is Xanthan.

17. The product in accordance with claim 12, in which said first salt is sodium citrate and said second salt is sodium chloride.

18. The product in accordance with any one of the preceding claims, in which said capsule-forming solution is a monovalent/divalent saline solution that consists of: an aqueous medium, an acid and a first divalent salt and a second monovalent salt.

19. The product in accordance with claim 18, in which the aqueous medium is water or another medium suitable for this purpose.

20. The product in accordance with one of claims 18 or 19, in which the acid preferably is citric acid or another acid suitable for use in foods and for the purpose of this invention.

21. The product in accordance with one of claims 18, 19 or 20, in which the first divalent salt preferably is a salt of an alkaline-earth metal.

22. The product in accordance with one of claims 18 to 21, in which said first salt is calcium chloride.

23. The product in accordance with one of claims 18 to 22, in which the second salt preferably is a sodium chloride salt.

24. The product in accordance with one of claims 18 to 23, in which said aqueous medium is between 88 and 90% by weight of said capsule-forming solution, said acid is between 3.0 and 3.5% by weight of the capsule-forming solution, and said first divalent salt and said second monovalent salt are between 7.0 and 8.0% by weight of said capsule-forming solution.

25. The product in accordance with any one of the preceding claims, in which said syrup consists of an aqueous medium, a polysaccharide and preservative salts.

26. The product in accordance with claim 25, in which said aqueous medium preferably is water or another medium suitable for this purpose.

27. The product in accordance with one of the claims 25 or 26, in which the polysaccharide preferably is saccharose or another polysaccharide suitable for use in foods and for the purpose of this invention.

28. The product in accordance with one of claims 25 to 27, in which the salts preferably are salts of potassium sorbate and sodium benzoate, or others appropriate for this purpose.

29. The product in accordance with any one of claims 25 to 28, in which the aqueous medium that is between 86 and 88% by weight of the syrup, the polysaccharide is between 12 and 14% by weight of the syrup, and the salts in a quantity between 0.08 and 0.1% by weight of the syrup.

30. The product in accordance with any one of the previous claims, in which a mixture of capsules is formed between the base mixture and said syrup.

31. The product in accordance with claim 30, in which the capsules are formed on pouring the capsule mixture drop by drop into said capsule-forming solution.

32. The product in accordance with claim 31, in which the capsules formed are homogeneous in size and have a dimension between 3.5 and 4.0 mm, a weight of approximately 0.045 g and a density of approximately 0.865 g/cm³.

33. The product in accordance with any one of claims 1 or 32, in which said product is a mixture between the capsules and said gelling medium.

34. The product of claim 33, in which the gelling medium consists generally of the following components: an aqueous medium, one or more polysaccharides, a gel-forming agent, a gelatinous protein, a salt, a first acid and a second acid and a flavoring agent.

35. The product of claim 34, in which the aqueous medium is drinking water or any other aqueous medium suitable for this purpose.

36. The product of any one of claims 34 or 35, in which the polysaccharide preferably is saccharose, or any other polysaccharide suitable for this type of product.

37. The product of any one of claims 34 to 36, in which the gel-forming agent preferably is carrageenan or another one suitable for this purpose.

38. The product of any one of claims 34 to 37, in which the gelatinous protein preferably is collagen or another one suitable for the purpose of this invention.

39. The product of any one of claims 34 or 38, in which the salt preferably is chosen from sodium citrate or another appropriate one.

40. The product of any one of claims 34 or 39, in which the first acid preferably is citric acid, although another appropriate one can be used, and the second acid preferably is ascorbic acid or another one appropriate for this purpose.

41. The product of any one of claims 34 to 40, in which lastly, the flavoring agent is chosen from among flavorings known in the art.

42. The product of any one of claims 34 or 41, in which the aqueous medium is between 77.5 and 80% by weight of the gelling medium, the polysaccharide is between 14.0 and 16.0% by weight of the gelling medium, the gel-forming agent and the gelatinous protein is between 4.0 and 4.5% by weight of the gelling medium, the salt and the first acid in a quantity between 0.9 and 1.2% by weight of the gelling medium, the second acid in a quantity between 0.03% and 0.05% by weight of the gelling medium and the flavoring agent in a quantity between 0.5 and 0.7% by weight of the gelling medium.

43. A process for preparing a product of edible capsules within a gel medium that comprises the stages of:
producing some edible capsules of various colors and flavors,
mixing the capsules and the gelling medium prior to starting gelling,
starting gelling,
packing the mixture into receptacles prior to completing gelling,
completing gelling

44. The process according to claim 43, in which the stage of producing some edible capsules of various colors and flavors comprises the stages of
preparing a base mixture,
preparing a capsule-forming solution,
preparing a syrup,
forming a mixture of base mixture and syrup,
forming the capsules by means of pouring said mixture of base mixture and syrup by drops into said capsule-forming solution,
rinsing and washing the capsules ready for forming the final product.

45. The process according to claim 44, in which the stage of preparing a base mixture comprises the stages of
preparing a vessel that has temperature control and stirring means with a heating and/or cooling system; there is added into the vessel between 0.5 and 0.7% of emulsifier by weight of the mixture and it is melted by heating to a minimum temperature of 70° C., wherein there is to be taken into account the hydro-liposoluble ratio with an HLB value between 14 and 16, which minimizes the diffusion of color between the capsules and the gel medium in the final product; once the emulsifier is melted, between 2.5 and 3.0% of oil-soluble flavor and between 0.65 and 0.75% of oil-soluble natural color defined as desired are added; the mixture is kept under constant stirring until the ingredients are completely homogenized at a minimum temperature of 70° C.; the preparation of the color and flavor mixture is carried out independently for each one of the defined colors and flavors; in a parallel manner, between 79 and 82% of the aqueous medium is heated to a maximum temperature of 80° C. without allowing boiling to occur in order to prevent evaporation; introducing into the whole of the polysaccharide that is between a 13.5 and a 14.5% by total weight of the base mixture, a first, a second and a third gelling agent that are between 0.8 and 1.0% by total weight of the base mixture and a salt between 0.25 and 0.35% in order to allow better incorporation and dissolution thereof in the final mixture; once all the preceding ingredients are mixed, they are to be added to the hot aqueous medium, with constant stirring until completely diluting all the mentioned ingredients and obtaining a base with mean viscosity of 500 mPa·s and a mean density of 1.0523 g/cm³; now the emulsion of integrated flavor and color is added to the preceding mixture, with constant stirring and at a maximum temperature of 80° C. until total dispersion thereof; once the dispersion is obtained, it is to be cooled rapidly to 25° C., with constant stirring to prevent the formation of lumps and the inclusion of air; this final base mixture is kept under stirring at 25° C., evaporation within the final mixture is to be avoided since with a lesser activity of water aw, the rheological characteristics within the base change, less fluidity occurring and preventing formation of the capsule; the components are as defined in claims 3 to 11.

46. The process according to one of claims 44 or 45, in which the stage of preparing a capsule-forming solution comprises the stages of
pasteurizing between 88 and 90% of aqueous medium at a temperature of 90° C. for 15 s; then it is cooled to ambient temperature of minimum 20° C. and a first divalent salt and the acid are added slowly; there now is added to the mixture a second monovalent salt which, together with the first, aids in increasing the elasticity and consistency of the capsules at the time of formation of same; said acid is between 3.0 and 3.5% by weight of said saline solution and said first and second salts are between 7.0 and 8.0% by weight of the saline solution; it is kept under constant, slow stirring, taking into account that an exothermic reaction is involved, it is kept at an approximate temperature of 80° C. until total dissolution of the ingredients; the physico-chemical variables, minimum pH of 1.4 and a minimum concentration of 8.5 degrees Baume are checked; now it is stored in the tank of the capsule-forming machine; the components mentioned are those defined in claims 18 to 24.

47. The process according to one of claims 44 or 46, in which the stage of preparing a syrup comprises the stages of
pasteurizing in the boiler between 86 and 88% by weight of the syrup, the aqueous medium at a temperature of 90° C. for 15 s; introducing into the total polysaccharide, which is between 12 and 14% by weight of the syrup, the preservative salts are in a quantity between 0.08 and 0.1% by weight of the syrup, to be added to the aqueous medium later on; cooling to a temperature of approximately 20° C. and storing the syrup in vessels disinfected beforehand, since this solution will be the conveying medium for the storage, preservation and subsequent dispersion of the capsules in the gelling medium; checking the physico-chemical variables of the syrup, minimum concentration 11.0 degrees Brix; keeping the syrup refrigerated until its use, for storage of the capsules formed in the machine.

48. The process according to one of claims 44 or 47, in which the stages of forming a mixture of the base mixture and syrup,
forming the capsules by means of pouring said mixture of the base mixture and syrup by drops into said capsule-forming solution, and
rinsing and washing the capsules ready for forming the final product, comprises the stages of
first of all the monovalent/divalent saline solution is placed in a storage tank that has a viscous flow recirculation system for said solution; secondly, the base mixture goes on to a dispensing hopper by means of pumping said mixture from the boiler to the dispensing hopper, up to a defined level, generating a column of fluid that ensures the pressure and speed of the flow; the base mixture flows from the base hopper through dispensing needles, forming a constant and homogeneous dripping that is to be checked visually for the purpose of ensuring the size and uniformity of same; said drops are received in the monovalent/divalent saline solution that is in said storage tank, which is a hardening medium for the capsules; as soon as contact of the drops of base mixture with said hardening medium occurs, the flavor and color capsule is formed, through contact with the calcium ion that adheres to the first and second gelling agent that immediately hardens through changes in the chemical characteristics that are perceived rheologically; the capsules are left submerged in said monovalent/divalent saline solution for an approximate time of 4 minutes, manifested by the travel of a conveyor belt that is used for evacuation of the capsules from the recirculation tank for the monovalent/divalent saline solution in the following stage of rinsing of the capsules; afterwards the size and weight of the capsules obtained, which should have an average diameter of 3.5 to 4.0 mm, an approximate weight of 0.045 g and a density of 0.865 g/cm³, are checked; after the capsules emerge from the monovalent/divalent saline solution, they go on to a second stage of spray washing with cold water, for the purpose of eliminating the residual salty taste and aiding in the hardening of the walls; the washing time is approximately 5 minutes. Then the washed flavor capsules are collected in the syrup mentioned above and are stored in a capsule:syrup ratio of 60:40, said syrup is used as a conveying medium during mixing with the gel base in order to ensure dispersibility in the final product; the capsules stored as intermediate product are stored in said syrup; storage is to be carried out at a temperature between 4 and 6° C.

49. The process according to one of claims 43 to 48, in which the stage of preparing a gelling medium comprises first placing the polysaccharide, between 14.0 and 16.0% by weight of the gelling medium, in a mixer, the dry elements are added thereto, that is, the gel-forming agent and the gelatinous protein, in a quantity between 4.0 and 4.5% by weight of the gelling medium, the salt and the first acid in a quantity between 0.9 and 1.2% by weight of the gelling medium, the second acid in a quantity between 0.03 and 0.05% by weight of the gelling medium and the flavoring agent in a quantity between 0.5 and 0.7% by weight of the gelling medium; now the aqueous medium of the formulation is heated to a minimum of 40° C. in order to ensure the dissolution of the mixture of dry products. The dry ingredients are added conveyed in a mixing cone in order to incorporate them into the aqueous medium of the formulation, with constant recirculation. Once all the ingredients are mixed and homogenized, the process of pasteurization is initiated at a minimum temperature of 75° C. for 15 s and afterwards it is cooled to 30° C. Then cooling to a temperature of maximum point 19° C. is undertaken prior to the start of gelling of the gel medium; the components mentioned are those defined in claims 34 to 41.

50. The process according to one of claims 44 or 47, in which the stages of mixing the capsules with the gelling medium until completing the gelling comprises the stages of storing the final product of the invention under the already defined temperature conditions in a finished-product tank under constant stirring in order to keep the obtained mixture fluid.
The difference in densities between the gelling medium (1.06 to 1.07 g/cm³) and the rigid capsule (0.860 to 0.870 g/cm³) ensures suspension in the fluid gelling medium at the defined temperatures; the product behaves as a Newtonian fluid with constant viscosity at a temperature of 19° C. When entry of the gelling medium into the finished-product tank begins, the preserved rigid capsules are added through the upper portion of the tank; this final mixture is kept under stirring for 10 minutes, during which time reduction of the temperature and consequently the gelling of the gelatinous protein is started; adjustment of the process in terms of temperature and speed of stirring makes it possible to ensure distribution of the capsules in the gelling medium and suspension thereof in the liquid, viscous gelling medium in the gelling phase, at this point the gelling medium behaves as a non-Newtonian fluid, that is, with variable viscosity at the same temperature; once the product is in this state with the capsules suspended, it then is routed by means of a pumping system to the packing stage, ensuring the integrity of the capsules on the way to a packing machine; once the product reaches a packing-machine hopper, the process of packing of the final product is initiated, in which there is a temperature control system in order to maintain the temperature within a tolerance of +/−1° C.; the product then is packaged in receptacles with suitable capacity; then, once the container has been filled with the edible capsules within gel, it is sealed with an aluminum foil strip; the materials that are used for packing of the product of this invention are subjected to a cleaning process in a hydrogen peroxide bath with a minimum concentration of 10% p/p by spraying, for the purpose of ensuring asepsis; afterwards the hydrogen peroxide is eliminated through evaporation and decomposition in water and O₂ in a drying chamber at a temperature between 130 and 135° C.; once the product has been packed, the presentation thereof as to suspension of the capsules and concentration of same is checked, and then it goes on to a refrigeration tunnel for the purpose of allowing finalization of the gelling process that had started in the mixing tank and ensuring the characteristics of the product.

51. A unit or machine for preparing a product of rigid capsules of colors and flavors within a gel medium, said machine comprises in general a piping that carries the base mixture that is being pumped from the manufacturing vessel; the mixture is discharged into a capsule-dispensing means; said dispenser consists essentially of a hopper that has a jacket for heating and/or cooling, with an inlet for the product, a level control and a connection for washing; in the lower portion there is a plate that has one or more needles with a diameter of 2.5 mm which generate the capsule-forming drops; preferably 200 needles are provided; as already mentioned previously, through the needles fall drops of the base mixture which harden upon falling into a tank filled with the monovalent/divalent saline solution, forming the capsules; there is a second tank that contains the same monovalent/divalent saline solution and a fluid conveyance system to recirculate said solution; inside the tank there is a conveyor belt serving to move the capsules out and route them to two water-shower and spray-washing stations to rinse and wash the capsules; now the capsules are stored mixed with the syrup and refrigerated; in a parallel manner, a mixing tank in which the gel medium is prepared is used; once it is prepared, it goes on to a final-product tank in which it is mixed with the mixture of capsules and syrup; said tank has means for stirring and temperature control; lastly, the final but not completely gelled product goes on to the packing machine wherein the product is packed in suitable containers for its subsequent sale to the user.
